(19) United States
(12) Patent Application Publication
(10) Pub. No.: US 2013/0028183 A1
(43) Pub. Date: Jan. 31, 2013

(54) METHOD AND APPARATUS FOR ROUTING CIRCUIT SWITCHED FALLBACK MESSAGING IN A WIRELESS COMMUNICATION SYSTEM

(71) Applicant: Stephan M. Praquin, Arlington Heights, IL (US)

(72) Inventor: Stephan M. Praquin, Arlington Heights, IL (US)

(73) Assignee: MOTOROLA MOBILITY, INC., Libertyville, IL (US)

(21) Appl. No.: 13/406,672

(22) Filed: Feb. 28, 2012

Related U.S. Application Data
(60) Provisional application No. 61/513,063, filed on Jul. 29, 2011.

(51) Int. Cl. H04W 92/02; H04W 60/00; H04W 40/34

(52) U.S. Cl. 370/328

(57) ABSTRACT

A multi-technology wireless communication system is provided that comprises a packet data network and a circuit switched network and that routes circuit switched fallback (CSFB) messages associated with a user equipment operating in the packet data network based on a circuit switched network access network identifier that identifies an Interworking Solutions function (IWS) of the circuit switched network that serves the user equipment. The circuit switched network access network identifier is maintained by a Node B of the packet data network and is provided to a serving Mobility Management Entity (MME) of the packet data network when implementing CSFB for the UE. The MME then selects an IWS of the circuit switched network for a routing of CSFB messaging based on the IWS identified in the circuit switched network access network identifier.

### FIELD OF THE INVENTION

The present invention relates generally to wireless communication systems, and more specifically to routing circuit switched fallback messaging in a wireless communication system implementing multiple air interface technologies.

### BACKGROUND OF THE INVENTION

The evolution of wireless communications has resulted in a proliferation of networks of different technologies and corresponding air interfaces. As a result, when a wireless user equipment (UE) establishes a communication session, multiple technologies and air interfaces, and correspondingly multiple radio access networks (RANs), may be available and accessible for a voice portion of the session. For example, the UE may be able to concurrently access a legacy circuit switched network (for example, a second generation (2G) or 2.5G network), such as a CDMA (Code Division Multiple Access) 1X or a CDMA 1xRTT (1X Radio Transmission Technology) network or a GSM (Global System for Mobile communications) network providing primarily circuit voice service, or a later generation packet data network, such as a 3GPP LTE (Third Generation Partnership Project Long Term Evolution) network, a 3GPP2 UMB (Third Generation Partnership Project 2 Ultra Mobile Broadband) network, a WiMAX network, or a Wireless Fidelity (Wi-Fi) network based on IEEE 802 standards, providing packet switched data services. The packet data network also may provide Voice over Internet Protocol (VoIP) services.

When a communication system includes both a packet data network and a circuit switched network, it may be beneficial to system performance for a UE operating in the packet data network to receive incoming voice calls and/or route outgoing voice calls via the circuit switched network. This is known as circuit switched fallback (CSFB). For example, channel conditions associated the circuit switched network may be more favorable than channel conditions associated with the packet data network or a system operator may prefer, for bandwidth or cost reasons, to establish the voice session with the circuit switched network. However, in order to implement CSFB, the packet data network, such as a Mobility Management Entity (MME) of a 3GPP LTE network, needs to be able to determine, and exchange signaling with, network elements serving a coverage area of the circuit switched network that corresponds to a coverage area serving the UE in the packet data network. Typically, the MME is coupled to the circuit switched network via a multiplicity of circuit switched network Interworking Solution Functions (IWSs) and a multiplicity of IWS interfaces and IWS interface modules, such as S102 interfaces with respect to a 3GPP LTE network, wherein each IWS serves a different coverage area of the circuit switched network.

Therefore, there is a need for a method and apparatus whereby the MME may determine an appropriate IWS, and an appropriate IWS interface module, for a routing of CSFB messaging to the circuit switched network for a UE active in the packet data network in a wireless communication system implementing CSFB.

### BRIEF DESCRIPTION OF THE DRAWINGS

FIG. 1 is a block diagram of a wireless communication system in accordance with various embodiments of the present invention.

FIG. 2 is a block diagram of a user equipment of FIG. 1 in accordance with an embodiment of the present invention.

FIG. 3 is a block diagram of a packet data network Node B of FIG. 1 in accordance with an embodiment of the present invention.

FIG. 4 is a block diagram of a circuit switched network wireless access node of FIG. 1 in accordance with an embodiment of the present invention.

FIG. 5 is a block diagram of a circuit switched network wireless access node controller of FIG. 1 in accordance with an embodiment of the present invention.

FIG. 6 is a block diagram of a Mobility Management Entity of FIG. 1 in accordance with an embodiment of the present invention.

FIG. 7 is a block diagram of an Interworking Solution Function of FIG. 1 in accordance with an embodiment of the present invention.

FIG. 8 is a block diagram of a Mobile Switching Center of FIG. 1 in accordance with an embodiment of the present invention.

FIG. 9A is a logic flow diagram illustrating a method executed by the communication system of FIG. 1 in routing, by the packet data network of FIG. 1, circuit switched fallback traffic to the circuit switched network of FIG. 1 in accordance with various embodiments of the present invention.

FIG. 9B is a continuation of the logic flow diagram of FIG. 9A illustrating a method executed by the communication system of FIG. 1 in routing, by the packet data network of FIG. 1, circuit switched fallback traffic to the circuit switched network of FIG. 1 in accordance with various embodiments of the present invention.

One of ordinary skill in the art will appreciate that elements in the figures are illustrated for simplicity and clarity and have not necessarily been drawn to scale. For example, the dimensions of some of the elements in the figures may be exaggerated relative to other elements to help improve understanding of various embodiments of the present invention. Also, common and well-understood elements that are useful or necessary in a commercially feasible embodiment are often not depicted in order to facilitate a less obstructed view of these various embodiments of the present invention.

### DETAILED DESCRIPTION OF THE INVENTION

To address the need for a method and apparatus whereby an MME may determine an appropriate IWS, and an appropriate IWS interface module, for a routing of circuit switched fallback (CSFB) messaging to a circuit switched network for a UE active in a packet data network in a wireless communication system implementing CSFB, a multi-technology wireless communication system is provided that comprises a packet data network and a circuit switched network and that routes circuit switched fallback messages associated with a user equipment operating in the packet data network based on a circuit switched network access network identifier that identifies an Interworking Solutions function (IWS) of the circuit switched network that serves the user equipment. The circuit switched network access network identifier is maintained by a Node B of the packet data network and is provided to a serving Mobility Management Entity (MME) of the packet data network when implementing CSFB for the UE. The MME then selects an IWS of the circuit switched network for a routing of CSFB messaging based on the IWS identified in the circuit switched network access network identifier.

Generally, an embodiment of the present invention encompasses a method for circuit switched fallback messages in a multi-technology wireless communication system comprising a packet data network and a circuit switched network. The method includes serving, by a Mobility Management Entity (MME) of the packet data network, a user equipment, receiving, by the MME, a circuit switched network access network identifier that identifies an Interworking Solutions function (IWS) of the circuit switched network that serves the user equipment, and routing circuit switched fallback messaging to the IWS identified in the circuit switched network access network identifier.

Another embodiment of the present invention encompasses a method for routing circuit switched fallback messages in a multi-technology wireless communication system comprising a packet data network and a circuit switched network. The method includes wirelessly serving a user equipment in the packet data network and maintaining, in the packet data network, a modified version of a Reference Cell Identifier, wherein the Reference Cell Identifier is modified to include an IWS identifier that identifies an IWS of the circuit switched network; that serves the user equipment in the circuit switched network.

Still another embodiment of the present invention encompasses a network element capable of operating in a packet data network of a multi-technology wireless communication system comprising the packet data network and a circuit switched network. The network element comprises multiple IWS interface modules, wherein each IWS interface module of the plurality of IWS interface modules is configured to interface between the network element and an IWS of the circuit switched network. The network element further comprises an at least one memory device that is configured to maintain an association between each IWS interface module of the multiple IWS interface modules and a corresponding IWS of the circuit switched network. The network element further comprises a processor coupled to the at least one memory device and that is configured to receive, in the packet data network and from a Node B of the packet data network, a circuit switched network access network identifier that identifies an IWS of the circuit switched network serving a user equipment, and to route circuit switched fallback messaging to the IWS identified in the circuit switched network access network identifier via a corresponding IWS interface module of the plurality of IWS interface modules.

Yet another embodiment of the present invention encompasses a Node B capable of operating in a packet data network of a multi-technology wireless communication system comprising the packet data network and a circuit switched network. The Node B comprises at least one radio frequency receiver, at least one radio frequency transmitter, and an at least one memory device that is configured to maintain a modified version of a circuit switched network access network identifier, wherein the a circuit switched network access network identifier comprises an IWS identifier that identifies an IWS of the circuit switched network that serves a user equipment in the circuit switched network. The Node B further comprises a processor configured to convey the circuit switched network access network identifier to an MME of the packet data network.

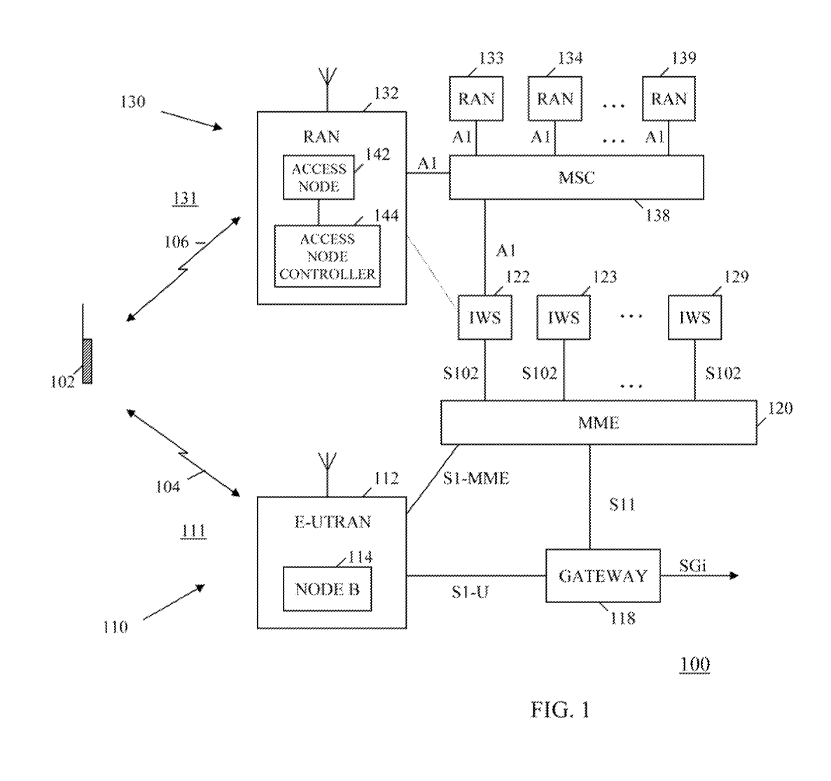

Turning now to the drawings, the present invention may be more fully described with reference to FIGS. 1-9B. FIG. 1 is a block diagram of a wireless communication system 100 in accordance with various embodiments of the present invention. Communication system 100 is a multi-technology wireless communication system that comprises both a packet data network 110 and a circuit switched network 130. Communication system 100 includes a wireless user equipment (UE) 102, for example but not limited to a cellular telephone, a radiotelephone, or a Personal Digital Assistant (PDA), personal computer (PC), or laptop computer equipped for wireless voice communications. UE 102 is capable of engaging in a packet data voice call with packet data network 110 of communication system 100 and is further capable of engaging in a circuit switched voice call with circuit switched network 130 of the communication system, and more particularly is capable of communicating with a Radio Access Network (RAN) 132 of the circuit switched network via a legacy protocol, such as a CDMA (Code Division Multiple Access) 1X or a CDMA 1xRTT (1X Radio Transmission Technology) protocol, and is capable of communicating with a RAN 112 of the packet data network via a later generation protocol, for example, via a 3GPP LTE (Third Generation Partnership Project Long Term Evolution) protocol.

Circuit switched network 130 includes multiple circuit switched network Radio Access Networks (RANs) 132-139 (eight shown). Each RAN of the multiple RANs 132-139 includes a wireless access node, such as access node 142 of RAN 132, which access node may be a Base Transceiver Station (BTS) or any other type of circuit switched network wireless access node known in the art. Each RAN of the multiple RANs 132-139 further includes a wireless access node controller that is operably coupled to the access node, such as access node controller 144 of RAN 132, which may be a Base Station Controller (BSC), a Centralized Base Station Controller (CBSC), a Radio Access Network Controller (RNC), or any other type of circuit switched network wireless access node controller known in the art. Circuit switched network 130 further includes at least one Mobile Switching Center (MSC) 138 that is coupled to one or more of the multiple RANs 132-139, preferably via an A1 interface.

Packet data network 110 includes a packet data RAN 112, such as an E-UTRAN (Evolved Universal Terrestrial Radio Access Network). RAN 112 includes a packet data network access node 114, such as a Node B, an eNode B, or a wireless Access Point (AP) or any other type of packet data network access node known in the art (which packet data network access nodes are collectively referred to herein as a “Node B”). Packet data network 110 further includes a Gateway 118 that is coupled to RAN 112, preferably via an S1-U interface, and a Mobility Management Entity (MME) 120 coupled to RAN 112, preferably via an S1-MME interface, and to Gateway 118, preferably via an S11 interface. Preferably, Gateway 118 comprises one or more of a Serving Gateway (Serving GWG) and a Public Data Network (PDN) Gateway.

Each of RAN 112 and RANs 132-139 provides wireless communication services to users equipment (UEs) located in a coverage area, such as a cell or a sector of a cell, of the RAN. For example, RAN 112 provides wireless communication services to UEs located in a coverage area 111 of the RAN via air interface 104, and RAN 132 provides wireless communication services to UEs located in a coverage area 131 of the RAN via air interface 106. Each air interface 104, 106 includes a forward link that includes a pilot channel, at least one forward link traffic channel, and forward link common and dedicated signaling channels. Each air interface 104, 106 further includes a reverse link that includes at least one reverse link traffic channel, reverse link common and dedicated signaling channels, and an access channel.

For purposes of the present invention, it is assumed herein that coverage area 111 of RAN 112, and in particular of Node B 114, of packet data network 110 substantially corresponds with the coverage area 131 of RAN 132, and in particular of access node 142, of circuit switched network 130. That is, it is assumed herein that there is a partial or a complete overlap of coverage area 111 with coverage area 131, such that a UE, such as UE 102, residing in at least a portion of coverage area 111 and provided wireless services by RAN 112, and in particular by Node B 114, also can be provided wireless services by RAN 132 and in particular by access node 142, and similarly a UE, such as UE 102, residing in at least a portion of coverage area 131 of RAN 132 and provided wireless services by RAN 132, and in particular by access node 142, also can be provided wireless services by RAN 112, and in particular by Node B 114 (herein also referred to as corresponding coverage areas). For example, such an overlap may include a one-to-one mapping of circuit switched network 130 sectors to packet data network 110 cells (for example, where a circuit switched network 130 sector uses the same antennas as a packet data network 110 cell), a one-to-many mapping of circuit switched network 130 sectors to packet data network 110 cells (for example, where a circuit switched network 130 sector is larger than a packet data network 110 cell and covers multiple packet data network 110 cells), or a many-to-one mapping of circuit switched network 130 sectors to packet data network 110 cells (for example, where a packet data network 110 cell is larger than a circuit switched network 130 sector and covers multiple circuit switched network 130 sectors).

Packet data network 110 and circuit switched network 130, and more particularly MME 120 of the packet data network and MSC 138 of the circuit switched network, communicate with each other via an Interworking Solution function (IWS). That is, MME 120 is coupled to multiple Interworking Solution functions (IWSs) 122-129 (eight depicted in FIG. 1). Each IWS 122-129 provides an interworking function between packet data network 110, and in particular MME 120, and a circuit switched network cell/sector/RAN served by the IWS. For example, IWS 122 provides an interworking function between packet data network 110, and more particularly MME 120, and RAN 132, access node controller 144, access node 142, and coverage area 131 of circuit switched network 130.

Each IWS 122-129 supports circuit switched network signaling with the circuit switched network 130. When circuit switched network 130 is a CDMA 1xRTT network, each IWS 122-129 supports A1/A1p signaling with the circuit switched network. As noted above, each IWS 122-129 also interfaces to packet data network 110, and in particular to MME 120, and also supports packet data signaling with the packet data network. For example, each IWS 122-129 may encapsulate circuit switched network signaling in packet data network signaling, thereby permitting a circuit switched message to be transported over the air to a UE in packet data network 110.

As depicted in FIG. 1, one or more of IWSs 122-129 is coupled to MSC 138. In various embodiments of the present invention, each IWS 122-129 further may be coupled to one or more of an access node and an access node controller of a circuit switched network RAN serviced by the IWS, for example, with respect to IWS 122, to one or more of access node 142 and access node controller 144 of RAN 132. While each IWS 122-129 is depicted as an entity separate from access nodes and access nodes controllers, in various embodiments of the invention, each IWS 122-129 may be included in a corresponding RAN, such as RAN 132 with respect to IWS 122, and may be implemented by one or more of an access node or an access nodes controller of the RAN, such as access node 142 and access node controller 144 of RAN 132. Together, the access nodes and access node controllers of RANs 132-139, Node B 114, Gateway 118, MME 120, IWSs 122-129, and MSC 138 may be collectively referred to as a communications network, or infrastructure, of communication system 100 and each such element of the communication system may also be referred to herein as a network element.

The above-listed interfaces are all known in the art and will not be described in greater detail herein. Furthermore, although single interfaces have been described herein between many of the network elements of communication system 100, each interconnection among elements may comprise multiple interconnections and/or interfaces, such as one or more of a signaling interface and a bearer interface or path, such a path for an exchange of voice information.

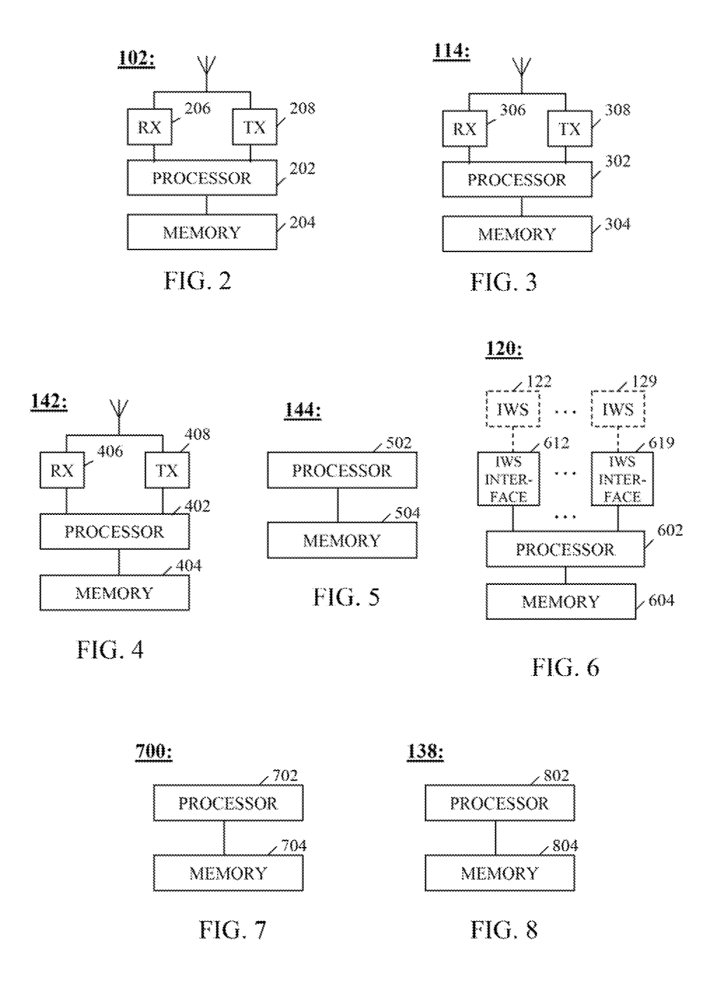

Referring now to FIGS. 2-8, architectures of UE 102, Node B 114, access node 142, access node controller 144, MME 120, an IWS 700, such as IWSs 122-129, and MSC 138, respectively, are provided in accordance with an embodiment of the present invention. Each of UE 102, Node B 114, access node 142, access node controller 144, MME 120, IWS 700, and MSC 138 includes a respective processor 202, 302, 402, 502, 602, 702, 802 such as one or more microprocessors, microcontrollers, digital signal processors (DSPs), customized processors, field programmable gate arrays (FPGAs), or combinations thereof or such other devices known to those having ordinary skill in the art, which processor is configured to execute the functions described herein as being executed by UE, Node B, access node, access node controller, MME, IWS, and MSC.

Each of UE 102, Node B 114, access node 142, access node controller 144, MME 120, IWS 700, and MSC 138 further includes a respective at least one memory device 204, 304, 404, 504, 604, 704, 804 such as but are not limited to a hard disk, a CD-ROM, an optical storage device, a magnetic storage device, random access memory (RAM), dynamic random access memory (DRAM), a ROM (Read Only Memory), a PROM (Programmable Read Only Memory), an EPROM (Erasable Programmable Read Only Memory), an EEPROM (Electrically Erasable Programmable Read Only Memory) a Flash memory, or equivalents thereof that is coupled to the processor and that maintains data and programs that may be executed by the associated processor and that allows the UE, Node B, access node, access node controller, MME, IWS, and MSC to perform all functions necessary to operate in communication system 100. When IWS 122 is implemented by access node 142 or access node controller 144, the IWS may implemented by a processor of the access node or access node controller (that is, processors 402 and 502) based on instructions maintained in an associated at least one memory device of the access node or access node controller (that is, at least one memory devices 404 and 504).

The at least one memory device 204 of UE 102 further may maintain preprogrammed information that facilitates a switching between networks 110 and 130. Additionally, the at least one memory device 304 of Node B 114 maintains a ‘circuit switched network access network identifier,’ such as a modified version of a Reference Cell Identifier (Reference Cell ID) in a CDMA 1X network, that includes an identifier of a corresponding coverage area, access node, and/or access node controller of circuit switched network 130. For example, the circuit switched network access network identifier maintained in the at least one memory device 304 of Node B 114 includes one or more of an identifier of coverage area 131, such as a Cell Identifier (Cell_ID), a Sector Identifier, or a Location Area Identifier (LAI), an identifier of access node 142, such as a Base Station Identifier (BS_ID), and an identifier of access node controller 144, such as a Base Station Controller Identifier (BSC_ID) or a Centralized Base Station Controller Identifier (CBSC_ID). However, unlike access network identifiers of the prior art, such as a prior art Reference Cell ID, the circuit switched network access network identifier further includes an identifier of the IWS (IWS ID) serving the coverage area/access node/access node controller, for example, IWS 122 with respect to coverage area 131, access node 142, and access node controller 144. The circuit switched network access network identifier may be pre-programmed into Node B 114 or may be dynamically determined by the Node B by monitoring identifiers in messaging conveyed to the Node B by, and/or from the Node B to, UEs served by the Node B.

MME 120 further includes multiple IWS interface modules 612-619 that are each in communication with processor 602. Each IWS interface module 612-619, such as an S102 interface module or an A21 interface module, provides an interface with a corresponding IWS 122-129 coupled to the MME, which association between the IWS interface module 612-619 and the corresponding IWS 122-129 is maintained in at least one memory device 604 of the MME. For example, MME 120 communicates with IWS 122 via IWS interface module 612, and thereby communicates with RAN 132, and in particular with access node 142 and access node controller 144, via IWS 122 and MSC 138, and further communicates with, via access node 142 and access node controller 144, UEs, such as UE 102, residing in coverage area 131 serviced by access node 142, and access node controller 144.

UE 102 further includes at least one radio frequency (RF) receiver 206 and at least one RF transmitter 208 in communication with processor 202 and that wirelessly receive signals from, and transmit signals to, the infrastructure of communication system 100, and in particular both RAN 112 and RAN 132. For example, UE 102 may communicate with one or the other of Node B 114 and access node 142, or communicate with both Node B 114 and access node 142 simultaneously. Similarly, each of Node B 114 and access node 142 further includes a respective at least one RF receiver 306, 406 and a respective at least one RF transmitter 308, 408 in communication with corresponding processors 302 and 402 and that wirelessly receive signals from, and transmit signals to, UEs serviced by the Node B 114 or access node 142, such as UE 102.

Unless otherwise specified herein, the functionality described herein as being performed by UE 102, Node B 114, access node 142, access node controller 144, MME 120, IWS 122, and MSC 138 is implemented with or in software programs and instructions stored in the respective at least one memory device 204, 304, 404, 504, 604, 704, 804 associated with the UE, Node B, access node, access node controller, MME, IWS, and MSC and executed by a processor 202, 302, 402, 502, 602, 702, 802 associated with the UE, Node B, access node, access node controller, MME, IWS, and MSC. However, one of ordinary skill in the art realizes that the embodiments of the present invention alternatively may be implemented in hardware, for example, integrated circuits (ICs), application specific integrated circuits (ASICs), and the like, such as ASICs implemented in one or more of the UE, Node B, access node, access node controller, MME, and MSC. Based on the present disclosure, one skilled in the art will be readily capable of producing and implementing such software and/or hardware without undo experimentation.

In order for UE 102 to engage in a communication session in either packet data network 110 or circuit switched network 130, each of UE 102, packet data network 110, and circuit switched network 130 operates in accordance with known wireless telecommunications protocols. Circuit switched network 130 is a legacy communication system, preferably a CDMA 1X or a CDMA 1xRTT (1X Radio Transmission Technology) network, that provides circuit switched communication services to subscribers serviced by the network (it may also provide packet data services) and that operates in accordance with legacy system standards, such as the CDMA 1X or CDMA 1xRTT standards. Packet data network 130 is a later generation communication system, preferably a 3GPP LTE communication system, that provides packet data communication services to subscribers serviced by the network. To ensure compatibility, radio system parameters and call processing procedures are specified by the standards, including call processing steps that are executed by an UE and a base station subsystem or other access network serving the UE and between the base station subsystem or other access network and associated infrastructure. However, those of ordinary skill in the art realize that packet data network 130 may operate in accordance with any one of a variety of wireless packet data communication standards that support multimedia packet data-based communication sessions, such as the 3GPP2 UMB standards, the WiMAX standards, and the IEEE (Institute of Electrical and Electronics Engineers) 802.xx standards, for example, the 802.11, 802.15, or 802.16 or 802.20 standards, and that circuit switched network 110 may operate in accordance with any one of a variety of well-known legacy wireless telecommunication standards, such as the Global System for Mobile communications (GSM) standards, that provide circuit switched communication services.

In communication system 100, while UE 102 is operating in packet data network 110, it may be desirable to establish a voice call or a voice portion of a communication session of the UE via circuit switched network 130. For example and as is known in the art, while roaming in communication system 100 and being serviced by RAN 112, UE 102 may receive a stronger signal from RAN 132. Typically signal strengths are determined by a UE, such as UE 102, measuring a pilot channel associated with the RAN. By way of another example, the costs associated with operating UE 102 on circuit switched network 130 may be less than the costs associated with operating UE 102 on packet data network 110, or an operator of communication system 100 may be desirous of utilizing the already built-out circuit switched network 130 for whatever services may be supported by the circuit switched network. By way of yet other examples, for load balancing purposes or for congestion relief, the operator of communication system 100 may find it desirable to utilize circuit switched network 130 for a voice call or a voice portion of a communication session of a UE, such as UE 102, active in packet data network 110.

In order to facilitate an establishment, in circuit switched network 130, of a voice call or a voice portion of a communication session of a UE, such as UE 102, active in packet data network 110, communication system 100 implements a circuit switched fallback (CSFB) voice call establishment scheme. That is, as known in the art (for example, 3GPP Technical Specification (TS) 23.272), a communication system, such as communication system 100, implementing both a packet data network and a circuit switched network may establish a voice call or voice portion of a communication session in the circuit switched network for a UE that is active in the packet data network. In addition, as part of its implementation of a CSFB scheme, communication system 100 implements CSFB services that support a CSFB scheme, such as UE registration in circuit switched network 130 via packet data network 110 and other messaging exchanged between the packet data network and the circuit switched network, such as message tunneling, for example, tunneling of voice communications or any other messaging in support of CSFB, between the circuit switched network and the packet data network.

When Node B 114 conveys CSFB signaling traffic to MME 120, the Node B includes a circuit switched network identifier that identifies a coverage area, such as a cell and/or a sector of a cell, of circuit switched network 130 that overlaps in coverage with the coverage area 111 served by the Node B, that is, such as coverage area 131. MME 120 then conveys the received CSFB signaling traffic to an IWS serving the access node of circuit switched network 130, that is, access node 142, that serves the identified coverage area, that is, coverage area 131 via a corresponding IWS. However, in order to communicate with access node 142, MME 120 must determine which IWS of the multiple IWSs 122-129 to communicate with and which IWS interface module of the multiple IWS interface modules 612-619 to utilize in such communications.

In order to facilitate such communications, communication system 100 provides a ‘circuit switched network access network identifier’ that comprises, as described above, an identifier of coverage area, access node, and/or access node controller of circuit switched network 130 corresponding to Node B or packet data network 110. For example, the circuit switched network access network identifier maintained in the at least one memory device 304 of Node B 114 includes an identifier of coverage area 131, such as a Cell Identifier (Cell_ID), a Sector Identifier, or a Location Area Identifier (LAI), an identifier of access node 142, such as a Base Station Identifier (BS_ID), and/or an identifier of access node controller 144, such as a Base Station Controller Identifier (BSC_ID) or a Centralized Base Station Controller Identifier (CBSC_ID). The circuit switched network access network identifier maintained in the at least one memory device 304 of Node B 114 further includes an identifier of an IWS (an IWS identifier, or IWS ID), that is, IWS 122, serving the corresponding coverage area of the circuit switched network 130, that is, coverage area 131, access node 142, and access node controller 144. The circuit switched network access network identifier may additionally include an MSC identifier (MSCID) identifying an MSC serving the coverage area, that is, MSC 138. For example, in one such embodiment of the present invention, the IWS ID may be an identifier that uniquely identifies an IWS in communication system 100. In another such embodiment of the present invention, when the IWS is implemented by a circuit switched network access node controller, the IWS ID associated with the IWS may be an identifier of the access node controller implementing the IWS, such as a BSC identifier (BSC_ID) or a CBSC identifier (CBSC_ID) or, when the IWS is implemented by a circuit switched network access node, the IWS ID associated with the IWS may be an identifier of the access node implementing the IWS. Thus, based on a circuit switched network access network identifier received from Node B 114, MME 120 is able to determine an IWS, and a corresponding IWS interface module, for a routing of the received CSFB signaling traffic.

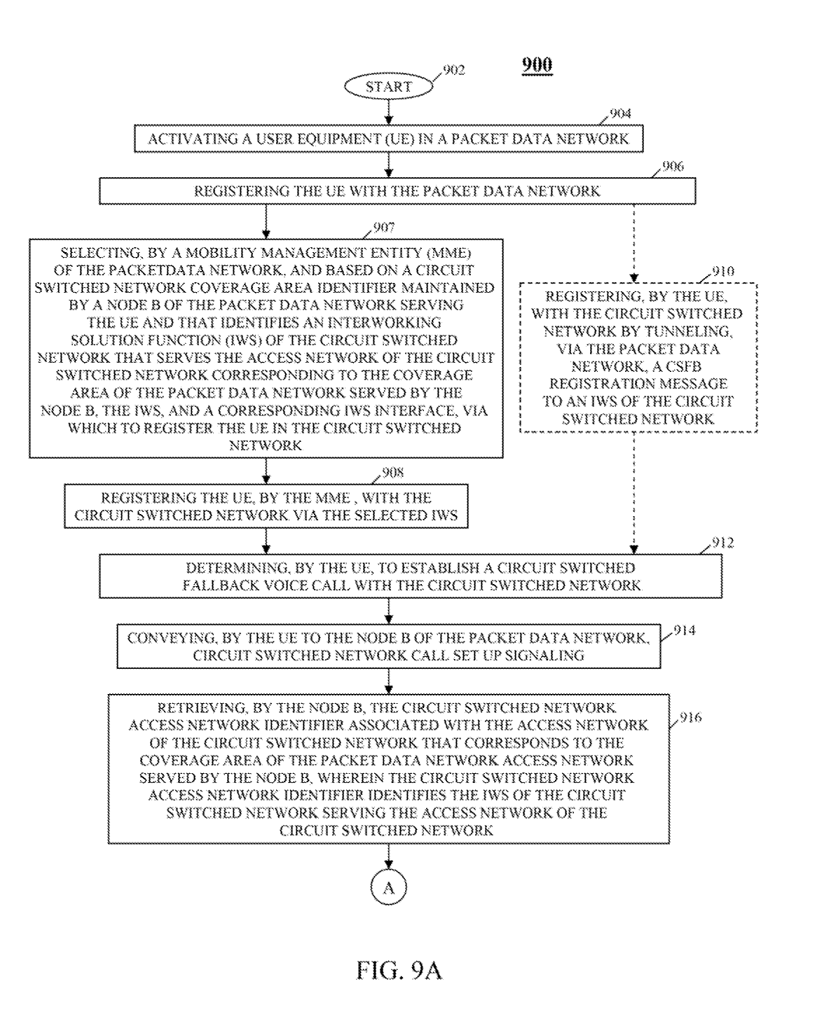

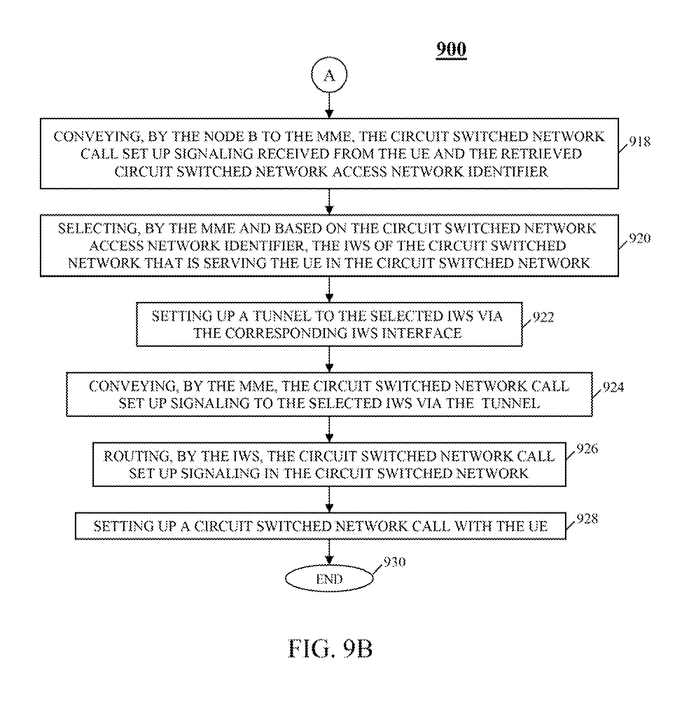

Referring now to FIGS. 9A and 9B, a logic flow diagram 900 is provided that illustrates a method executed by communication system 100 in routing, by packet data network 110, CSFB messages to circuit switched network 130 in accordance with various embodiments of the present invention. Logic flow diagram 900 begins (902) when UE 102 activates (904) in and connects with packet data network 110. For example, the activation may be a result of the UE powering up in packet data network 110 or may be a result of the UE roaming into the packet data network. As part of the activation process, the UE registers (906) with packet data network 110.

The packet data network, and in particular MME 120, then may register the UE with associated circuit switched network 130, and in particular MSC 138. For example, the 3GPP standards (TS 23.272) provide a mechanism whereby a UE, such as UE 102, may request of a packet data network, such as packet data network 110, and in particular an MME of the packet data network, such as MME 120, that the UE be registered with both the packet data network and a corresponding circuit switched network, such as circuit switched network 130. Under the 3GPP standards, the MME acts as a Serving Gateway Support Node (SGSN) with respect to an MSC of the circuit switched network, so that the MSC thinks that the UE is attached to a circuit switched network rather than a packet data network and performs a location update via the perceived SGSN. In one embodiment of the present invention, when the UE registers with the MME, the MME provides the UE with a packet data network location identifier, such as a Tracking Area Identifier for an LTE network. In communication system 100, as part of the registration process, Node B 114 provides to MME 120 a circuit switched network access network identifier maintained by the Node B and, based on the circuit switched network access network identifier, the MME registers the UE with an MSC of the circuit switched network 130, that is, MSC 138, serving the coverage area circuit switched network 130, that is, coverage area 131, in which the UE resides.

In order to determine an appropriate IWS and corresponding IWS interface module to use when communicating with circuit switched network 130, the circuit switched network access network identifier includes the IWS identifier (IWS ID) identifying the IWS serving the coverage area, that is, coverage area 131, of circuit switched network 130 that corresponds to the coverage area served by the Node B, that is, coverage area 111. Based on the circuit switched network access network identifier, and in particular by reference to the IWS ID included in the circuit switched network access network identifier, MME 120 selects (907) an IWS, that is, IWS 122, and a corresponding IWS interface module, that is, IWS interface module 612, associated with the coverage area of circuit switched network 130 serving UE 102, that is, coverage area 131. MME 120 then registers (908) UE 102 in circuit switched network 130, and in particular with MSC 138, by conveying registration information to the circuit switched network/MSC via an inter-network tunnel (such as an A21 tunnel or an S102 tunnel) between MME 120 and IWS 122.

In another embodiment of the present invention, UE 102 may initiate a separate CSFB registration procedure (910) with circuit switched network 130 via packet data network 110, that is, separate from the initial registration with packet data network 110. For example, UE 102 may tunnel a CDMA 1x Registration Message to IWS 122 via packet data network 110, and in particular Node B 114 and MME 120, wherein the routing of the CDMA 1x Registration Message is based on an IWS ID included in a circuit switched network access network identifier (for example, a Reference Cell Identifier that is modified to include an IWS ID) that is sent together with the tunneled CDMA 1x Registration Message from Node B 114 to MME 120.

In still other embodiments of the present invention, UE may convey or tunnel any type of reverse link signaling message to IWS 122 via packet data network 110, and in particular via Node B 114 and MME 120, wherein the routing of the reverse link signaling message is based on an IWS ID included in a circuit switched network access network identifier (for example, a Reference Cell Identifier that is modified to include an IWS ID) that is sent together with the reverse link signaling message. For example but not intending to limit the invention in any way, the reverse link signaling message may be a short message service (SMS) message such as an Application Data Delivery Service (ADDS) message or an authentication message such as a Shared Secret Data (SSD) message.

When UE 102 determines (912) to establish a CSFB voice call with circuit switched network 130, for example, to originate a voice call in the circuit switched network, to receive a voice call in the circuit switched network, or to handover a voice call to the circuit switched network, the UE assembles, and conveys to (914) to Node B 114, circuit switched network call set up signaling (for example, 1X Air Interface Origination Signaling). Node B 114 then retrieves (916), from at least one memory device 304 of the Node B, the circuit switched network access network identifier comprising the IWS ID that identifies the IWS serving the UE in circuit switched network coverage 130, that is, IWS 122, and routes the circuit switched network call set up signaling and circuit switched network access network identifier to MME 122. For example, the circuit switched network access network identifier may be a modified version of a Reference Cell ID as known in the art, which Reference Cell ID is modified to include an identifier of the IWS serving the UE in circuit switched network coverage 130, that is, IWS 122. Node B 114 then conveys (918) the circuit switched network call set up signaling and circuit switched network access network identifier to MME 120 in an Uplink S1 CDMA2000 tunneling message.

In response to receiving the circuit switched network call set up signaling from the UE, and based on the IWS identified by the circuit switched network access network identifier, MME 120 selects (920) an IWS, that is, IWS 122, and a corresponding IWS interface module, that is, IWS interface module 612, serving UE 102 in circuit switched network 130. MME 120 sets up a tunnel (922) to IWS 122 via a corresponding IWS interface module of the MME, that is IWS interface module 612, and conveys (924) the circuit switched network call set up signaling to IWS 122 using an inter-network tunnel/protocol (such as an A21 or S102 tunnel/protocol). IWS 122 then routes (926) the circuit switched network call set up signaling in circuit switched network as appropriate to set up the call in circuit switched network 130, for example, to one or more of MSC 138 and access network controller 144, and the MSC and access network controller set up (928) a circuit switched network call with UE 102 in accordance with known circuit switched network call set up procedures. Logic flow diagram 900 then ends (930).

By providing, by Node B 114 to MME 120, a circuit switched network access network identifier that identifies an Interworking Solutions function (IWS) of the circuit switched network that serves UE 102 in the circuit switched network, MME 120 does not have to maintain a database listing all MSCs, access node controllers, access nodes, and/or coverage areas of circuit switched network 130 that may be accessed by the MME and, in association, with each such MSC, access node controller, access node, and/or coverage area, an IWS serving the MSC, access node controller, access node, and/or coverage area. As an MME may be able to access a significant number of MSCs, access node controllers, access nodes, and/or coverage areas, such a database could be substantially large. Furthermore, each time a link between an IWS and a circuit switched network element is changed, which can be frequent, such a database would have to be modified. Thus, by providing the circuit switched network access network identifier that identifies the IWS of the circuit switched network that serves the UE, a system configuration and maintenance burden on an operator of the system is reduced.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for routing circuit switched fallback messages in a multi-technology wireless communication system comprising a packet data network and a circuit switched network, the method comprising:
serving, by a Mobility Management Entity (MME) of the packet data network, a user equipment;
receiving, by the MME, a circuit switched network access network identifier that identifies an Interworking Solutions function (IWS) of the circuit switched network that serves the user equipment; and
routing circuit switched fallback messaging to the IWS identified in the circuit switched network access network identifier.

2. The method of claim 1, wherein the circuit switched network access network identifier comprises a modified version of a Reference Cell Identifier, wherein the Reference Cell Identifier is modified to include an Interworking Solutions function (IWS) identifier that identifies the IWS of the circuit switched network.

3. The method of claim 1, wherein the circuit switched fallback messaging comprises reverse link signaling conveyed by the user equipment to the packet data network.

4. The method of claim 3, where in the circuit switched fallback messaging comprises one or more of registration information for registering the user equipment with the circuit switched network, a short message service message, and an authentication message.

5. The method of claim 1, where in the circuit switched fallback messaging comprises call set up signaling.

6. The method of claim 1, wherein routing comprises setting up an inter-network tunnel between the Mobility Management Entity and the Interworking Solutions function.

7. A method for routing circuit switched fallback messages in a multi-technology wireless communication system comprising a packet data network and a circuit switched network, the method comprising:
wirelessly serving a user equipment in the packet data network; and
maintaining, in the packet data network, a modified version of a Reference Cell Identifier, wherein the Reference Cell Identifier is modified to include an Interworking Solutions function (IWS) identifier that identifies an IWS of the circuit switched network; that serves the user equipment in the circuit switched network.

8. The method of claim 7, further comprising providing the modified version of the Reference Cell Identifier to a Mobility Management Entity of the packet data network.

9. A network element capable of operating in a packet data network of a multi-technology wireless communication system comprising the packet data network and a circuit switched network, the network element comprising:
a plurality of Interworking Solutions function (IWS) interface modules, wherein each IWS interface module of the plurality of IWS interface modules is configured to interface between the network element and an IWS of the circuit switched network;
an at least one memory device that is configured to maintain an association between each IWS interface module of the plurality of IWS interface modules and a corresponding IWS of the circuit switched network; and
a processor coupled to the at least one memory device and that is configured to receive, in the packet data network and from a Node B of the packet data network, a circuit switched network access network identifier that identifies an IWS of the circuit switched network serving a user equipment, and to route circuit switched fallback messaging to the IWS identified in the circuit switched network access network identifier via a corresponding IWS interface module of the plurality of IWS interface modules.

10. The network element of claim 9, wherein the circuit switched network access network identifier comprises a modified version of a Reference Cell Identifier, wherein the Reference Cell Identifier is modified to include an Interworking Solutions function (IWS) identifier that identifies the IWS of the circuit switched network.

11. The network element of claim 9, wherein the circuit switched fallback messaging comprises reverse link signaling conveyed by the user equipment to the packet data network.

12. The method of claim 11, where in the circuit switched fallback messaging comprises one or more of registration information for registering the user equipment with the circuit switched network, a short message service message, and an authentication message.

13. The method of claim 9, where in the circuit switched fallback messaging comprises call set up signaling associated with the user equipment.

14. The method of claim 9, wherein routing comprises setting up an inter-network tunnel between the network element and the Interworking Solutions function.

15. A Node B capable of operating in a packet data network of a multi-technology wireless communication system comprising the packet data network and a circuit switched network, the Node B comprising:
at least one radio frequency receiver;
at least one radio frequency transmitter;
an at least one memory device that is configured to maintain a modified version of a circuit switched network access network identifier, wherein the a circuit switched network access network identifier comprises an Interworking Solutions function (IWS) identifier that identifies an IWS of the circuit switched network that serves a user equipment in the circuit switched network; and
a processor configured to convey the circuit switched network access network identifier to a Mobility Management Entity of the packet data network.

16. The Node B of claim 15, wherein the circuit switched network access network identifier comprising a modified version of a Reference Cell Identifier, wherein Reference Cell Identifier is modified to include the Interworking Solutions function (IWS) identifier.

17. The Node B of claim 15, where in the processor further is configured to route, to the Mobility Management Entity, circuit switched fallback messaging received from the user equipment.

18. The Node B of claim 17, wherein the circuit switched fallback messaging comprises reverse link signaling conveyed by the user equipment to the packet data network.

19. The method of claim 18, where in the circuit switched fallback messaging comprises one or more of registration information for registering the user equipment with the circuit switched network, a short message service message, and an authentication message.

20. The method of claim 17, where in the circuit switched fallback messaging comprises call set up signaling associated with the user equipment.
